(19) United States
(12) Patent Application Publication
(10) Pub. No.: US 2026/0167428 A1
(43) Pub. Date: Jun. 18, 2026

(54) METHOD FOR MANAGING AN ORDER-PICKING STATION

(71) Applicant: Exotec Product France, Croix (FR)

(72) Inventor: Louis ESQUERRE-POURTERE, Villeneuve d'Ascq (FR)

(73) Assignee: Exotec Product France, Croix (FR)

(21) Appl. No.: 19/417,693

(22) Filed: Dec. 12, 2025

(30) Foreign Application Priority Data
Dec. 13, 2024 (FR) FR2414115

(51) Int. Cl. B65G 1/137; B65G 1/06

(52) U.S. Cl. CPC B65G 1/1378; B65G 1/065; B65G 2203/0283

(57) ABSTRACT

A method for managing an order-picking station, at which a human or robotic operator places or removes articles in containers carried by automated guided vehicles travelling on a track of the station, including, with each change of operator at the station, the following cycle: sending a personalization request including an identifier of the operator from the station to a remote server; determining, by the remote server, the information for adjusting the height of the track to the operator; returning a personalization response including the adjustment information from the remote server to the station; and automatically adjusting the height of the track with respect to the floor by an internal mechanism of the station, on the basis of the adjustment information.

### FIELD

The invention relates to the technical field of methods for managing order-picking stations, also referred to as workstations, in particular within Automated Storage and Retrieval Systems (ASRS). Automated guided vehicles, also referred to as automatic transport vehicles, move along one or more tracks, also referred to as conveyor tracks.

### BACKGROUND

When working with goods conveyors, operators are required to perform a number of work tasks on orders contained in containers routed by the conveyors. To this end, one or more workstations may be provided. The term “conveyor” refers to a system or device designed to transport goods, products, or materials from one point to another within a logistics or industrial facility. These systems automate the movement of loads, optimize workflows, and improve operational efficiency by reducing human effort and the time required for transport. The ergonomics of work posts is an important aspect of automated storage systems.

The tasks performed can be strenuous if the position of the operator is not properly adapted. In addition, the routed articles or containers that operators work on can vary in size. This diversity of containers can lead to frequent changes of position.

It is known to position adjustable platforms next to workstations so that the working height of the operator can be adjusted. In fact, rather than standing on the floor or on a fixed structure, the operator can climb onto a platform and lower or raise the height thereof to improve their comfort.

This adjustment can especially be made according to the height of the operator, so that they can achieve a working height that is perfectly adapted to their morphology. However, this consideration is just one example among many situations where a height adjustment may be necessary. For example, certain operators prefer to limit the range of their movements to reduce muscle fatigue, which requires positioning the work area at a specific height. Similarly, poor vision may prompt an operator to move closer to the articles in order to identify them more easily or handle them with greater precision.

In addition, certain tasks involve handling heavy or bulky articles, making it essential to minimize the distance between the arms or hands of the operator and the articles themselves, thereby reducing physical strain and improving ergonomics. The nature of the orders to be processed can also play a decisive role: articles requiring high precision, delicate handling, or increased effort to grasp often call for fine adjustment of the working height. Ultimately, there are a number of work situations that involve adjusting the working height of the operator.

That being said, elevated platforms have the following disadvantages.

First, their presence necessarily involves a step to access them, which requires operators to climb up and down regularly, thereby increasing the risk of falls. This risk is all the greater given that several operator shifts may take place each day at the same post, increasing the likelihood of incidents.

Furthermore, these platforms require installing bulky and costly structures, which clutter the warehouse and significantly reduce the available space. This reduction impacts not only the circulation of operators and equipment, but also the storage capacity, which is essential for optimizing logistics operations. Furthermore, once on the platform, the operator is confined to a restricted space. To overcome this limitation and cover several work posts or areas, it may be necessary to design large platforms, which further exacerbates the problems of cluttering, cost, and adaptation to the warehouse space.

It is also known to tilt containers routed by a vehicle towards an operator in order to facilitate access by the operator. In document EP4385922, the angle of inclination of the container can also be adapted to the height of the operator. However, the degree of inclination is necessarily limited.

In document WO2024013453, it is envisaged to adjust the height of the parking space of the vehicle transporting a container according to the dimensions of the container being transported. But this adjustment is only applicable to operators of average size.

The object of the present disclosure is therefore to at least partially overcome the disadvantages of the prior state of the art cited hereinbefore.

According to previously described prior art, it is therefore known to use additional platforms, which are movable with respect to the zone for order-picking by the operator:
which are relatively bulky within the overall storage system,
which also have relatively limited ergonomics for the human operators who have to use them,
such platforms being, for robotic operators, such as robotic arms, for example,
either not very compatible with these fixed robotic operators, due to their movable nature,
or rather complex if they need to be made stationary with respect to the zone for
order-picking by the robotic operator that is attached thereto.

### SUMMARY

The invention has identified that the difficulties encountered in the prior art stemmed from the underlying strategy of adapting the operator—whether human or robotic, two very different types—to the track of the order-picking station.

The invention is based on a reverse strategy, that consists in making the track of the order-picking station adaptable to the operator, whether human or robotic. In the case of human operators, this adaptation concerns a broad category of men and women. More precisely, it aims to adapt the height of this track by making it adjustable according to the operator.

This track height is the key parameter for optimizing the operator's work post.

Indeed, for a human operator, it is essentially the variation of the optimal working height during order picking that creates the greatest constraints for this human operator and that will require the most effort and the most deviations from a natural and optimized posture or from natural and optimized gestures for preparing the orders, such as standing up, bending down, stretching, etc., resulting in two major disadvantages:
a significant health risk (lumbago, cramps, joint fatigue and locking, etc.) for the human operator,
a risk of a reduction in the efficiency of the human operator at their work post, since they might not be working in the best position or with the best gestures,
the invention aiming herein to improve both the health and the performance of the human operator, rather than sacrificing one for the other in the unfortunately more conventional manner,
and always with a view to sparing the human operator, a mechanism internal to the order-picking station is used to modify the height of this track, in an almost automatic manner (only requiring the human operator to log into their work post, which they already do anyway), while remaining simple and effective.

Moreover, for a robotic operator, it enables the use of a simpler, more effective and more robust robot, as the robotic operator only needs to be able to work at a single height, to which the track of the order-picking station will adapt, and optionally also according to the type of automated guided vehicle travelling on the track, as well as according to the type of container carried by the automated guided vehicle travelling on the track. The result is a significant reduction in costs, with the use of a simpler, more robust robot.

As a result, at a work post at a track that is automatically height-adjustable by an internal mechanism, the invention makes it possible to:
improve the long-term health and performance of a human operator,
and/or simplify and extend the service life of the robotic operator used,
combine the two sets of advantages for complex order-picking stations, using one or more human operators together with one or more robotic operators, a robotic operator advantageously being a robot or a robotic system,
while reducing the footprint of the order-picking station, which in turn:
also reduces the risk of falls and accidents in the environment of the order-picking station,
and also improves the overall efficiency of the order-picking station.

To this end, the present invention proposes a method for managing an order-picking station, at which a human or robotic operator places or removes articles in containers carried by automated guided vehicles travelling on a track in the station, comprising, with each change of operator at the station, the following cycle:
sending a personalization request, including an identifier of the operator, from the station to a remote server also connected to several other order-picking stations,
determining, by means of the remote server, on the basis of the identifier of the operator, information for adjusting the height of the track to the operator,
returning a personalization response, including the adjustment information, from the remote server to the station,
automatically adjusting the height of the track with respect to the floor by means of an internal mechanism of the station, on the basis of the adjustment information.

The invention has also identified that this new strategy for adapting to the operator could be more broadly extended to a strategy for adapting to a change, not only of operator, but more generally to a change in the configuration and/or operation of the order-picking station. A preferential example of a change in the configuration of the order-picking station is a change of operator. A preferential example of a change in the operation of the order-picking station is a change in the type of container, for example, a change in the shape or a change in one or more dimensions of the container, especially such as its depth, or a change in the loading of the container, for example, a change in the type of articles contained in the container, or a change in the type of storage of the articles inside the container.

Also here, the strategy is based on the same novel principle of adapting the order-picking station to the change in the environment, rather than, so as to prevent the order-picking station from having to adapt to the change, having to impose this adaptation on each operator, whether human or robotic, through greater constraints and efforts.

According to the invention, a method is then provided for managing an order-picking station, at which a human or robotic operator places or removes articles in containers carried by automated guided vehicles travelling on a track of the station, comprising, upon a change of configuration and/or operation at the station, the following cycle:
determining, by means of a remote server also connected to several other order-picking stations, after the change in configuration and/or operation at the station, information for adjusting the height of the track to the change in configuration and/or operation at the station,
returning the adjustment information from the remote server to the station,
automatically adjusting the height of the track with respect to the floor by means of an internal mechanism of the station, on the basis of the adjustment information.

In a first family of embodiments, a method for managing an order-picking station is also provided, comprising:
the change of configuration and/or operation includes a change of operator,
the cycle also comprises, prior to the determining step, sending an identifier of the operator from the station to the remote server,
the determining step is carried out by the remote server, on the basis of the identifier of the operator, and determines information for adjusting the height of the track to the operator.

In a second alternative family of embodiments, a method for managing an order-picking station is also provided, comprising:
the change of configuration and/or operation includes a change in the type of container and/or a change in the loading of the container arriving on the track, without changing the operator,
the information for adjusting the height of the track is determined in such a way that the cumulative height, from the floor, of the new type of container carried by the automated guided vehicle travelling on the track, remains adapted to the operator.

According to preferred embodiments, the invention comprises one or more of the following features, which may be used separately or in partial combination with one another, or in full combination with one another, with any one of the subjects of the aforementioned invention.

Preferably, the information for adjusting the height of the track is determined in such a way that the cumulative height, from the floor, of the container carried by the automated guided vehicle travelling on the track, is adapted to the operator.

Thus, not only is the track adapted to the operator, but it is also adapted to the type of container carried by the automated guided vehicle travelling on the track.

Preferably, the information for adjusting the height of the track is determined in such a way that the cumulative height, from the floor, of the container carried by the automated guided vehicle travelling on the track, is adapted to the height of the operator standing on the floor.

Thus, not only is the track adapted to the operator, but it is also adapted to the type of container carried by the automated guided vehicle travelling on the track.

Preferably, after the adjustment, each time a new type of container arrives on the track, the method for managing the order-picking station comprises the following container cycle:
dynamically adapting, by means of the remote server, the information for adjusting the height of the track so that the cumulative height, from the floor, of the new type of container carried by the automated guided vehicle travelling on the track, remains adapted to the operator,
returning dynamically adapted adjustment information from the remote server to the station,
automatically and dynamically adjusting the height of the track with respect to the floor by means of the internal mechanism of the station, on the basis of the dynamically adapted adjustment information, at the moment at which the new type of container carried by the automated guided vehicle travelling on the track reaches the operator.

Thus, not only is the track adapted to the operator, but it is also adapted to the type of container carried by the automated guided vehicle travelling on the track, this dual adaptation being carried out dynamically, i.e. potentially permanently.

Preferably, after the one or more adjustments, at each change of the depth at which the operator places or removes an article, the method for managing an order-picking station comprises the following depth cycle:
dynamically adapting, by means of the remote server, the information for adjusting the height of the track so that the cumulative height, from the floor, of the container carried by the automated guided vehicle travelling on the track, subtracting the depth at which the operator places or removes an article, as they fill or empty the container, remains adapted to the operator,
returning dynamically adapted adjustment information from the remote server to the station,
automatically and dynamically adjusting the height of the track with respect to the floor by means of the internal mechanism of the station, on the basis of the dynamically adapted adjustment information, as the operator fills or empties the container. The depth is the dimension along a vertical axis. The subtracted depth is measured from the top of the container.

Thus, the adaptation to the operator is even more fine-tuned in that it takes into account, potentially permanently, the emptying or filling state of the container handled by the operator, so that the operator can be spared even this limited adaptation effort.

Preferably, in addition to the one or more automatic adjustments, the operator can fine-tune the height of the track by manual adjustment, by sending, at the station, an instruction for the internal mechanism to raise or lower the height of the track, which then fine-tunes the height of the track to match the instruction.

Thus, despite all the improvements made to the system for automatically adjusting the height of the track, this height was still not brought up to an ideal level, or in the event of a malfunction, this height can still be adjusted manually by the (human) operator, who is thus assured of having the height of the track that suits them perfectly, even if this ideal height does not match the height determined by the automatic adjustment system on the basis of the data relating to the operator to which it has access.

Preferably, the total vertical travel for adjusting the height of the track is between 100 mm and 300 mm, or between 150 mm and 250 mm.

Thus, this travel range is optimized insofar as it makes it possible, in the considered application:
to accommodate almost any size of operator, human or robotic,
without needing an overly sophisticated internal mechanism (in the order-picking station) to cover this entire travel.

Preferably, this cumulative height is between 800 mm and 1600 mm, or between 1000 mm and 1400 mm.

Thus, this height range is optimized insofar as it allows, in the considered application:
to accommodate almost any size of operator, human or robotic,
without needing an overly sophisticated internal mechanism (in the order-picking station) to cover this entire height.

Preferably, in addition to the height of the track, the adjustment information also includes at least one other ergonomic characteristic of the track or of the order-picking station, and the internal mechanism also automatically, and where appropriate dynamically, modifies this other ergonomic characteristic to match the adjustment information.

Thus, the management method benefits from the fact that the layout of the track will be modified, in order to adjust not only its height, but also one or more of its other layout or operating parameters.

Preferably, this other ergonomic characteristic is a function of the height of the track.

Thus, the management method benefits from the potential synergy between the various parameters to be adjusted.

Preferably, the other ergonomic characteristic or one of the other ergonomic characteristics is an inclination of the track towards the operator at operator level.

Thus, another interesting parameter, albeit considerably less important than the height of the track, is also adapted to the operator.

Preferably, the inclination of the track is between an angle of 5 degrees and an angle of 15 degrees to the horizontal, or between an angle of 7 degrees and an angle of 11 degrees to the horizontal, with the opening of the container facing the operator at operator level.

Thus, this angular displacement range is optimized insofar as it makes it possible, in the considered application:
to accommodate almost any size of operator, human or robotic,
without needing an overly sophisticated internal mechanism (in the order-picking station) to cover this entire angular displacement.

Preferably, the other ergonomic characteristic or one of the other ergonomic characteristics belongs to the following list of ergonomic characteristics:
the height of a scanner of the track or of the order-picking station,
the height of a screen of the track or of the order-picking station,
a display parameter on a screen of the track or of the order-picking station, especially one of the following:
the color palette used for the display on a screen of the track,
the display language on a screen of the track,
the replacement of one type of alert with another type of alert, at the order-picking station:
for example, the replacement of an audible alert with a visual alert displayed on a screen of the order-picking station.

Thus, other interesting parameters, albeit considerably less important than the height of the track, are also adapted to the operator, and not just to the height of the operator, but also to other specific features of the operator, in particular human, such as their hearing, sight or language, so that the work post can be optimized for any human operator, overcoming both the barrier of a physical handicap (sight or hearing, for example) and the barrier of a different mother tongue.

Preferably, the circulation track of the station comprises, consecutively from the floor:
a first stationary portion, in the form of a first ascent ramp with a fixed slope,
a second movable portion comprising:
a second ascent ramp with a variable slope, connected by a pivot to the first ascent ramp,
a third descent ramp towards the operator, with a fixed or variable slope,
the height of the track is changed by moving the second movable portion.

Thus, this two-part structure, with one stationary part of larger extent and the other movable of smaller extent, makes it possible:
to meet the technical requirements, enabling the height of the track to be adjusted within the required range, simply and effectively,
to adjust the height of the track while limiting the cost and complexity of the movable parts of the track.

Preferably, the personalization response comprises additional information for adjusting the height of an additional track of the station, and the internal mechanism of the station also automatically adjusts the height of the additional track with respect to the floor on the basis of the additional adjustment information.

Thus, several tracks that are discrete from each other, and even optionally different from each other, can be managed by the management method and by the same management system implementing the management method.

Preferably, either the height of the track contained in the adjustment information is identical to the height of the additional track contained in the additional adjustment information, or the height of the track contained in the adjustment information is different from the height of the additional track contained in the additional adjustment information.

Thus, an even more fine-tuned adjustment, discrete across the various track types, can be achieved.

Preferably:
the track of the station is a track for the circulation of containers carried by automated guided vehicles, the containers:
reaching the operator empty, the operator then filling them with articles,
and moving away from the operator once filled,
the additional track of the station is a track for the circulation of containers carried by automated guided vehicles, the containers:
reaching the operator full, the operator then emptying them of their articles,
and moving away from the operator once emptied.

Thus, the track for the passage of the empty containers to be filled, as well as the track for the passage of the full containers to be emptied, with the full containers for storing products being emptied into the order containers destined for customers outside the storage system globally managed by the management method according to the invention or according to one embodiment of the invention.

Preferably, the internal mechanism of the station comprises one or more cylinders, preferably two cylinders, located under the track or under the tracks, so that the one or more tracks can be raised or lowered.

Thus, the structure of the internal mechanism of the station is both simple and effective for adjusting the height of the track, while remaining robust, since this adjustment often takes place several times a day (with each change of operator), and sometimes even several times an hour (with each change in the type of container, at certain times).

Preferably, the cycle comprises, before sending the personalization request: the operator logging into their station, using their identifier.

Thus, the management method uses a simple way of recognizing the operator so that the height of the picking station can be adjusted to the recognized operator, this identification often having already been performed by the operator for other reasons, for example, the time spent clocked in at the work post. In the latter case, the management method takes advantage of a task already performed by the operator, without asking the operator to perform any additional task.

Preferably, the operator identifier is:
either in the form of a barcode to be read by a scanner of the order-picking station,
or in the form of facial recognition of the operator that is seen by a camera of the order-picking station.

Thus, the technique for identifying the operator is both simple and effective.

Preferably, the order-picking station belongs to a group of order-picking stations in a warehouse, and:
the remote server comprises:
a first sub-server,
dedicated to the warehouse staff,
managing the adjustment information,
a second sub-server,
dedicated to managing the flow of containers within the warehouse,
of empty containers,
and/or of containers filled with identical articles from an article storage area in the warehouse,
and/or of containers filled with identical or different articles directed towards an order storage area or an order dispatch area,
managing the dynamically adapted adjustment information.

Thus, the simple structure of the management server associated with the management method enables the tasks of the management method to be carried out effectively.

Preferentially, the workstation of a conveyor for processing orders contained in containers comprises a conveyor track configured to route the containers, the conveyor track comprising a working portion, adjacent to and elevated with respect to a working area Z upon which an operator is positioned, the working portion being configured so that the operator can perform operations on the containers routed by the conveyor track, the conveyor track comprising a fixed part and a movable part, the movable part comprising the working portion, the workstation further comprising an internal adjustment mechanism of the conveyor track configured to adjust a height of the working portion, the height being measured with respect to a reference height of the working area of the operator, by moving the movable part of the conveyor track with respect to the fixed part.

Preferentially, the workstation according to the present disclosure has a working portion adjustable in height, typically in a vertical direction, forming part of the conveyor track. This configuration improves operator ergonomics and efficiency by allowing optimal access to the containers, thus reducing fatigue and increasing productivity. This also allows the working height to be adapted quickly and precisely based on the specific needs of the operator or the features of the containers, thus enhancing the flexibility and adaptability of the workstation.

Such a solution makes it possible, where applicable, to dispense with additional elevation platforms, thereby eliminating the risk of falls associated with such platforms. This also eliminates the clutter and cost associated with these platforms.

In addition, the presence of a movable part integrating the working portion on which the containers are routed allows continuity to be maintained in the conveyor flow during the adjustment of the working height. This allows high order processing rates to be achieved, thus optimizing the overall efficiency of the conveyor system.

Other characteristics and benefits of the invention will become apparent upon reading the following description of a preferred embodiment of the invention, given by way of example with reference to the attached drawings.

### BRIEF DESCRIPTION OF THE DRAWINGS

FIG. 1 is a schematic depiction of a conveyor and a working area on the floor, according to one example,

FIG. 2 is a top view of the conveyor of FIG. 1, showing different sizes of container being routed and an operator standing in the working area, ready to work on the containers,

FIG. 3 is, in views 3A and 3B, two non-exhaustive examples of conveyor tracks,

FIG. 4 is a schematic depiction of a first example of a workstation according to the present disclosure,

FIG. 5 is a schematic depiction viewed from the top of a second example of a workstation according to the present disclosure, wherein the movable part of the conveyor track forms one end of the conveyor track,

FIG. 6 is a schematic depiction viewed from the side of the example of a workstation of FIG. 6,

FIG. 7 is a schematic depiction viewed from the top of a particular example of a workstation comprising two conveyor tracks,

FIG. 8 is a depiction viewed in perspective of a particular example of a workstation,

FIG. 9 is a side view of the example shown in FIG. 8,

FIG. 10 is a cross sectional view of a particular example comprising two particularly visible cylinders.

FIG. 11 schematically depicts the sequence of events in an example of a method for managing an order-picking station according to one embodiment of the invention.

### DETAILED DESCRIPTION

The drawings and the disclosure below contain, for the most part, elements of a definite nature. They can therefore be used not only to improve understanding of the present disclosure, but also to contribute to defining it, where applicable.

In the various figures, the same references designate identical or similar elements. For the sake of brevity, only those elements that are useful for understanding the embodiment disclosed are depicted in the figures and are described in detail below.

In the following disclosure, when reference is made to absolute position qualifiers, such as the terms “front,” “rear,” “top,” “bottom,” “left,” “right,” etc., or relative qualifiers such as “above,” “below,” “upper,” “lower,” etc., or orientation qualifiers such as “horizontal,” “vertical,” etc., reference is made, unless otherwise specified, to the orientation of the figures or of an automatic transport vehicle in its normal position of use. Furthermore, the term “substantially” is to be interpreted as indicating that the result obtained is as precise as the known method used to measure it.

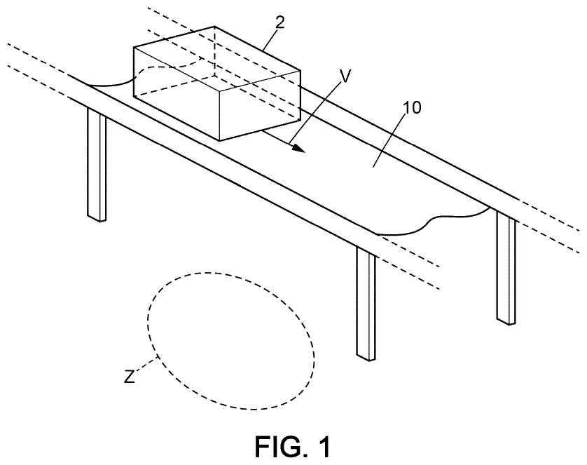

Reference is now made to FIG. 1, which shows a workstation 1 of a conveyor. Such a workstation 1 is especially intended to process orders contained in containers 2, which are routed to the workstation 1.

Such processing typically includes picking orders, but also checking, loading, unloading, and other operations. Order picking is carried out on articles arriving in product containers for transshipment into order containers, the product containers and order containers themselves being able to be carried or contained in storage containers carried by automatic transport vehicles or automated guided vehicles.

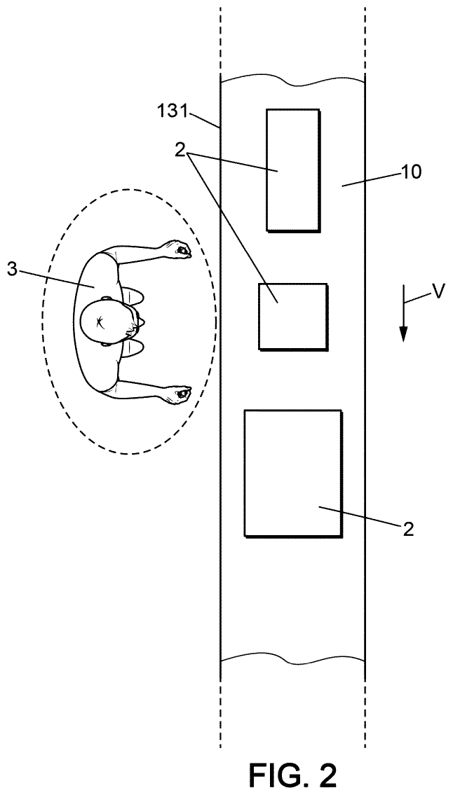

The containers 2 can be of various sizes and weights. As especially shown in FIG. 2, containers 2 of different sizes can be routed to the workstation 1.

The workstation 1 comprises a conveyor track 10 configured for routing the containers 2, typically from another portion of conveyor located upstream of workstation 1.

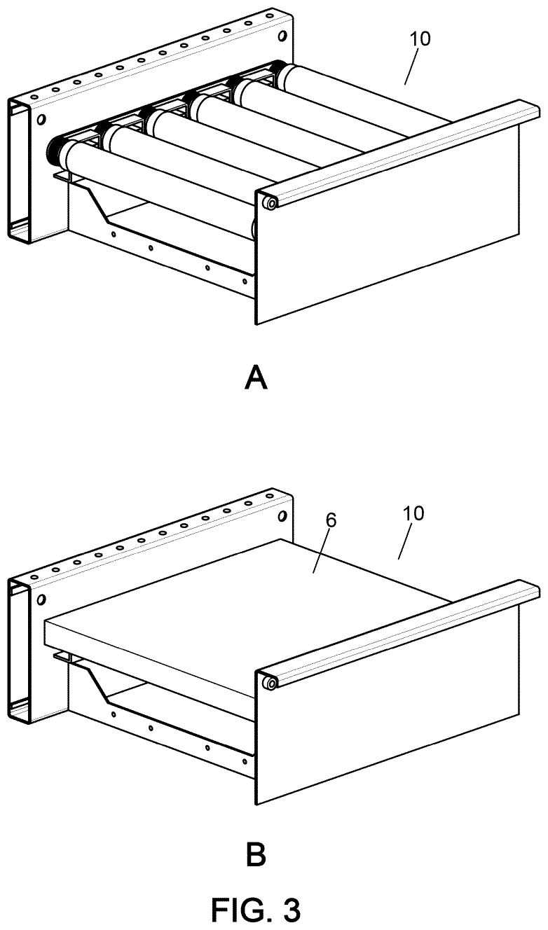

By “configured for routing”, it is understood that the conveyor track 10 can, according to a first example especially illustrated in FIG. 3a, comprise movable members such as rollers to set the containers 2 in motion. According to a known embodiment, at least one of the rollers may be motorized and transmit the rotational torque to the other rollers via transmission belts.

According to another example, especially illustrated in FIG. 3b, the conveyor track 10 comprises a lane 6, forming a substantially planar surface on which the containers 2 can roll. Such solution can especially be adapted for the routing of containers 2 by motorized Automated Guided Vehicles 7 (AGVs).

The workstation 1 is further provided at a working area Z wherein an operator can stand to work at the workstation.

The operator can typically be a human operator, but can also be a robot or robotized installation.

The workstation can be placed on the floor, and the working area Z can be an area on the floor.

In another example (not shown), the working area Z can be an area provided on a platform, distinct from the floor. For example, it can be a platform raised with respect to the floor.

In general, the working area Z, either on the floor or on a platform, allows the operator to stand at a so-called “reference” height H0.

The conveyor track 10 further comprises a working portion 13, adjacent to and positioned at an elevation with respect to working area Z.

Here, “adjacent” means that the working portion 13 can, for example, be defined as a portion of the workstation 1 that includes a working edge 131 proximate to the working area Z of the operator. In this fashion, said working portion 13 is configured so that operator 3 can perform operations on the containers 2 routed by the conveyor track 10 from the working area Z. Typically, the operator may be required to stand on one side of said working edge 131, and perform an operation on a container 2 located on the other side of said working edge 131.

Such working portion 13 is “elevated” with respect to the working area Z, in that it comprises a height H measured in relation to the reference height H0 of the working area Z. Typically, the height H is greater than the height H0, so that the working portion 13 is raised with respect to the working area Z, making the working portion 13 easily accessible to the operator. According to a particular example, the height H of the working portion 13 can vary within an ergonomic height range suitable for the operator.

Typically, the height of the working portion 13 is the height H with respect to the working area Z, the height H is typically measured at the level of said working edge 131. For example, the reference height H0 of the working area Z may be zero, and the height H may be for example between 65 and 110 cm, to optimize the ergonomics of the post. In other cases, if the working area Z is not on the floor, and is located on a platform for example, the reference height H0 could be the height of said platform, and the height H of the working portion 13 could be between 65 and 110 cm in addition to the height H0 of the working area Z.

### The workstation 1 may comprise a frame 100, for example fixed to the floor, on which conveyor track 10 is mounted.

The conveyor track 10 further comprises a fixed part 15 and a movable part 14. The fixed part 15 of the conveyor track 10 is a portion of the conveyor track secured to the frame 100. The movable part 14 is then movable with respect to the fixed part 15.

In general, the fixed part 15 of the conveyor track can extend substantially horizontally, at least in the vicinity of the junction with the movable part 14.

The movable part 14 of the workstation 1 further comprises the working portion 13. Thus, the working edge 131 of the working portion 13 is movable with the movable part 14 of the conveyor track 10.

According to the present disclosure, the workstation 1 comprises an internal adjustment mechanism 4 of the conveyor track 10 configured to move the movable part 14 with respect to the fixed part 15, so as to adjust a height of the working portion 13 carried by the movable part 14.

The term “internal mechanism” refers to a mechanism that is an integral part of the workstation 1 and is therefore physically and structurally connected to other elements of said workstation. More specifically, the internal adjustment mechanism 4, as described in this disclosure, is configured to allow for a height guidance of the movable part 14 of the conveyor track 10, which is used to transport the containers 2, and with respect to the fixed part, or even preferably configured to raise the height of the movable part. This configuration ensures that the adjustment of the movable part is performed directly by means of an internal guidance within the workstation, and preferably by means of an internal actuator within the workstation, and thus preferably without the intervention of external height adjustment components for the height actuation. In this fashion, by virtue of the internal adjustment mechanism 4, it is possible to adjust a height H of the working portion 13 with respect to the height H0 of the working area Z of the operator by moving the movable part 14 of the conveyor track 10 with respect to the fixed part 15.

In particular, the working portion 13 is set in motion and moves by a height ΔH to vary its height H. As previously disclosed, the height values are measured with respect to a reference height H0 of the working area Z.

The height variation ΔH permitted by the adjustment mechanism can be positive or negative. In this way, the working portion 13 can be raised or lowered, especially with the aim of improving the ergonomics of the workstation 1.

In general, the conveyor track 10 can present a general direction V according to which the containers 2 progress. Such a general direction V typically corresponds to an elongation direction of the conveyor track.

According to a particular example, the movable portion 14 of the conveyor track 10 is connected to the fixed part 15 or to the frame 100 in a rotatable manner by a joint 5 presenting an axis of rotation extending transversely to direction V. The adjustment of the height H of the working portion 13 being performed by rotation of the movable part 14 with respect to the fixed part 15 about said joint 5.

In other words, the axis of rotation of the joint 5 can be substantially perpendicular to the elongation direction of the conveyor track 10, typically horizontal.

Typically, the movable part 14 comprises a proximal edge, in the vicinity of the fixed part 15, which it is advantageous to maintain at the same height as the fixed part 15, so that the routing of the containers 2 proceeds unhindered. In this way, the joint 5, preferably positioned at this proximal edge, allows the height of the working portion 13 to be varied by rotation.

In particular, the movable part 14 of the conveyor track 10 can extend lengthwise following general direction V from said joint 5 up to a distal end 101, the working portion 13 being adjacent to said distal end 101. A lever arm is thus formed, so that the height of the movable part 14, at the joint 5, remains unchanged, whereas it varies at the working portion 13 located at a distal end 101 of the movable part 14.

As a result, adjusting the height of the working portion 13 leads to a variation in the inclination of the movable part 14: a slope is formed downstream of the joint 5. In order to minimize the variation in inclination, so as to minimize the impact on the routing of the containers 2 passing through the joint 5, the distance L between the working portion 13 and the axis of the joint 5 may be dimensioned to be relatively large. For example, this distance L could be greater than 1 meter, or even greater than 1.5 meters, or even greater than 2 meters.

Especially, such a distance L may be measured between the axis of the joint and an edge of the working portion 13 closest to said axis of the joint 5, such an edge may be defined as being distant from the working edge 131 by a distance equal to the dimension of the largest container being intended to be routed on the working portion 13.

According to another example, such a distance may be measured between the working edge 131 and the axis of the joint.

Advantageously, the variation in inclination Δθ (or otherwise referred to as “angular displacement”) can be between −5° and +5° with respect to the horizontal plane. In other words, it could be advantageous for the distance between the working portion 13 and the axis of the joint 5 to be greater than 1 meter, or even greater than 1.5 mm, or even greater than 2 meters, or even greater than 2.5 meters so as to achieve a height adjustment displacement of the working portion 13 in the vertical direction of at least plus or minus 100 mm (±100 mm) with respect to a nominal position of the working portion, corresponding to an angular displacement of the movable part about the axis of the joint less than or equal to plus or minus 5°, and preferably plus or minus 4°, for example plus or minus 2°, i.e., a limited angular displacement.

According to one embodiment, and for a nominal position of the working portion 13 corresponding to a nominal angle of inclination of the working portion 13 which can be of 9°(within ±3°) towards the working area, a variation in the angular displacement of the movable portion 14 about the nominal angle of inclination results in a vertical adjustment displacement of the working portion at least equal to plus or minus 100 mm (±100 mm) about the height of the working portion 13 when in its nominal inclination.

For example, the distance between the working portion 13 and the axis of the joint 5 can be 3 meters, and the nominal angle of inclination of the working portion 13 is 9°. A variation of plus 2° above the nominal position generates a positive elevation of plus 104 mm, and a negative elevation below the nominal position generates a negative elevation of minus 104 mm.

The variation in inclination Δθ of the movable part 14 is therefore a consequence of the height adjustment of the working portion, which it may be desirable to attenuate.

In particular, the conveyor track 10 of the workstation 1 may comprise a first routing portion 11 and a second routing portion 12 connected to each other by the working portion 13. In this case, the working portion 13 constitutes a segment of a path for the containers 2, between two portions of the conveyor track 10, via which the containers 2 “pass”. The conveyor track 10 is then configured to route containers 2 through the first routing portion 11 up to the second routing portion 12 passing via the working portion 13.

According to certain examples, it may be provided that the automated vehicles and/or the conveyor track 10 be configured to temporarily stop the routing of the containers 2 at the working portion 13, for the time it takes the operator to perform the desired operation.

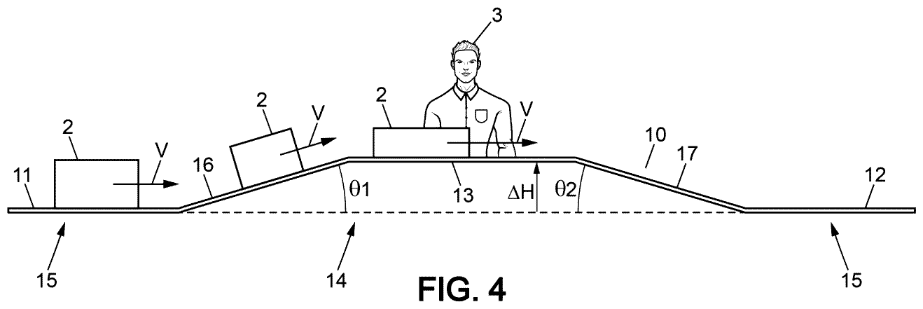

A particular example of a workstation 1 is depicted in FIG. 4.

In this example, the working portion 13 is comprised between a first routing portion 11 and a second routing portion 12.

The containers 2 are routed from the first routing portion 11 up to the second routing portion 12 passing via the working portion 13. Thereby, the containers are routed according to a main direction V.

The internal adjustment mechanism 4 (not shown in this example) may typically include cylinders, one end of which is connected to the fixed frame 100, and another movable end is connected to the movable part 14. The adjustment mechanism 4 is configured to adjust a height H of the working portion 13 by varying it by a height ΔH.

In this example, the displacement in height ΔH of the working portion 13 performs a variation in inclination of the conveyor track 10, especially by creating a first slope 16 of a first inclination θ1, and a second slope 17 of a second inclination θ2 opposite to the first inclination.

According to the example depicted, the first slope 16 is ascending and a second slope 17 is descending. Of course, according to the value of the height variation ΔH, which can also be negative, the first slope 16 can be descending and the second slope 17 can be ascending.

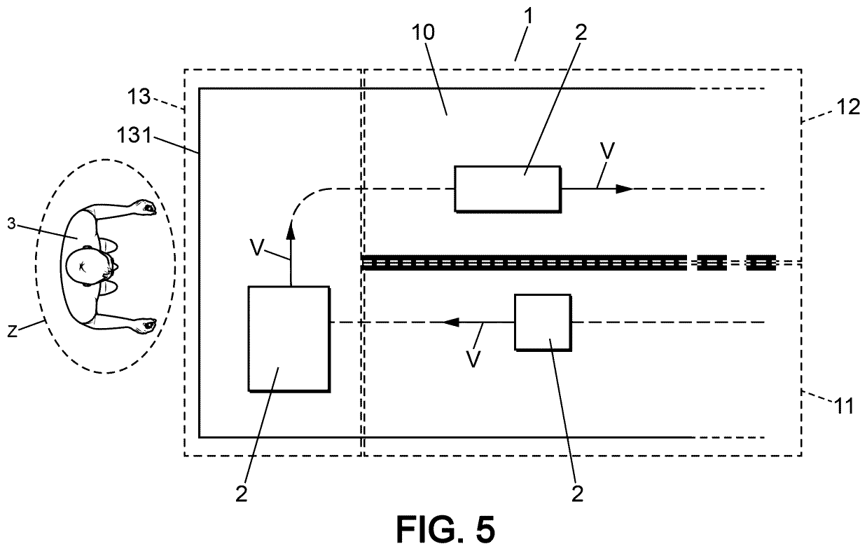

Another example of a workstation 1 is depicted in FIG. 5.

In this example, the first routing portion 11 and the second routing portion 12 extend alongside one another, both on the same side of the working portion 13. In this fashion, the working portion 13 forms one end of the conveyor track 10, so that the containers 2 are routed, prior to the intervention of the operator, in a first direction of travel towards the working portion 13, then in a second direction of travel opposite to the first direction of travel, moving away from the working portion 13 after the intervention of the operator.

According to a particular example, and especially as depicted, the conveyor track can form a “U” shape, with the first routing portion 11 and the second routing portion 12 being distinct from one another.

According to certain examples, the first routing portion 11 can be a portion of the conveyor track via which the containers 2 pass to reach the working portion 13, and the second routing portion 12 can be a portion of the conveyor track 10 via which the containers 2 pass as they leave the working portion 13.

Furthermore, it is possible for the first routing portion 11 and the second routing portion 12 to merge, and for the containers 2 to reach the working portion 13 and leave it via the same path.

In general, the conveyor track 10 presents a general direction V, which defines the direction according to which the containers 2 progress. In the particular example shown in FIG. 5, direction V typically corresponds to the general direction of extension of the conveyor track 10, along which the containers 2 progress to the working portion 13 and according to which they leave it.

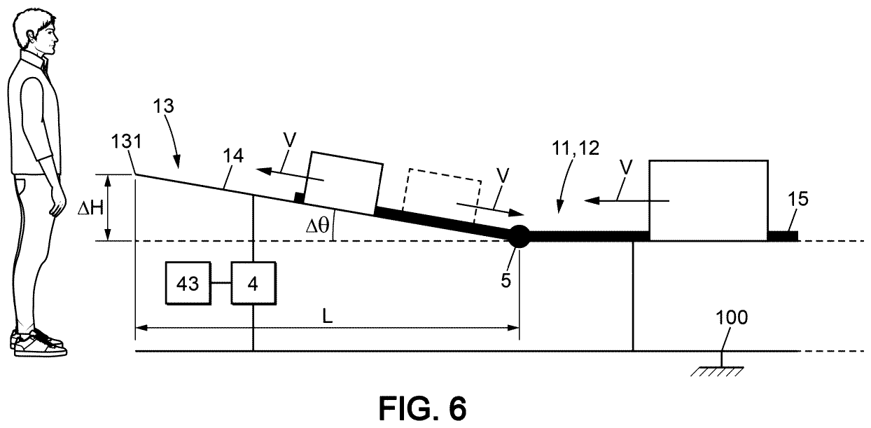

According to a particular example, and especially as depicted in FIG. 6, the movable portion 14 of the conveyor track 10 is rotatably connected to the fixed part 15 by a joint 5 extending transversely to direction V.

In fact, the joint 5 allows the movable part 14 to rotate with respect to the fixed part 15 along an axis that cuts transversely across direction V.

Preferably, the axis of joint 5 is substantially perpendicular to general direction V.

According to this example, the joint 5 is such that an adjustment of the height H of the working portion 13 causes a variation in the inclination Δθ of the feed direction V of the conveyor track 10 at the movable part 14. The change in inclination of the feed direction V can typically take place in a vertical plane, as depicted in the example in FIG. 6.

In this fashion, it is possible to adjust the height of the working portion 13, and thus vary its height by a value ΔH while the containers 2 progress from the fixed part 15 to the movable part 14. The creation of a slope, as a result of a variation in the height of the working portion 13, may in fact make it possible to avoid interrupting the flow of containers 2 during the adjustment.

Such a variation in inclination Δθ of direction V corresponds to a variation in inclination of the movable part 14.

To this end, the workstation 1 can include an actuator 43, configured to vary the height H of the movable part, typically by inclining the movable part 14 with respect to the fixed part 15.

The actuator 43 can for this purpose comprise a first end of 431 pivotally mounted on the fixed part 15 of the conveyor track 10 and a second end 432 pivotally mounted on the movable part 14 of the conveyor track 10, in such a way that an extension or retraction of the actuator allows the height of the working portion 13 to be adjusted.

In particular, “mounted on the fixed part” herein means that the first end 431 of the actuator 43 is mounted on a part secured to the fixed part 15, for example, the frame 100, or even directly on the floor on which the fixed part 15 is mounted.

According to a particular example, the movable part 14 of the conveyor track 10 extends lengthwise following general direction V from said joint 5, and ends with a distal end 101 adjacent to the working portion 13, so that the working area is adjacent to said distal end 101 of the movable part 14.

Typically, said distal end 101 comprises a working edge 131 of the working portion 13. Such a working edge 131 separates the working area Z wherein an operator is located from the working portion 13 to which the containers 2 are routed. In practice, according to one example, the operator stands on a first side of the working edge 131 at the working area Z and reaches the containers 2 on a second side of the working edge 131.

In particular, the movable part 14 of the conveyor track 10 extends lengthwise according to general direction V over a distance L that can be greater than 1 meter, preferably greater than 2 meters.

In fact, it may be advantageous for the said distance L, which separates the distal end 101 from the joint 5, to be relatively large. Depending on the scale of the desired height variation, and for the same height variation ΔH, the variation in inclination Δθ is less significant if the distance L is large. In this fashion, the slope formed by the joint 5 does not hinder the routing of the containers 2.

Typically, the height adjustment of the working portion 13 is such that the variation in height ΔH, measured in relation to the reference height of the working area Z of the operator, is greatest at the working edge 131 of the working portion 13.

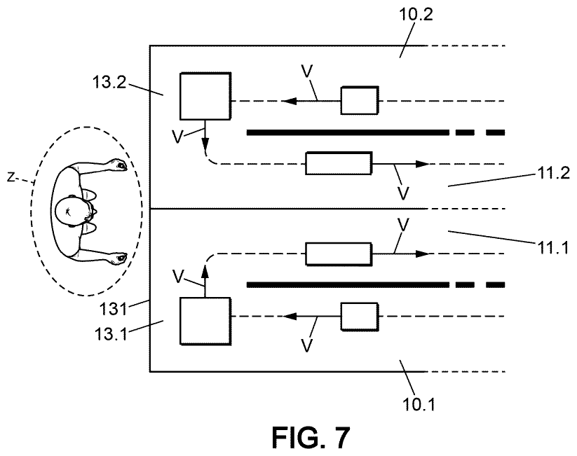

According to a particular example depicted in FIG. 7, the workstation 1 comprises a first conveyor track 10.1 and a second conveyor track 10.2 extending alongside one another, so that a first working portion 13.1 of the first conveyor track 10.1 is positioned next to a second working portion 13.2 of the second conveyor track 11.2.

In this case, the internal adjustment mechanism 4 is configured to adjust the height of each of the working portions 13.1, 13.2 of the first and second conveyor tracks 10.1, 10.2.

Advantageously, it is possible for the adjustment of the first working portion 13.1 and the second working portion 13.2 to be independent of each other. To this end, the internal mechanism 4 can comprise at least two actuators, with a first actuator connected to the first conveyor track 10.1 and a second actuator connected to the second conveyor track 10.2, so that the heights of the two working portions 13.1, 13.2 can be adjusted independently of each other.

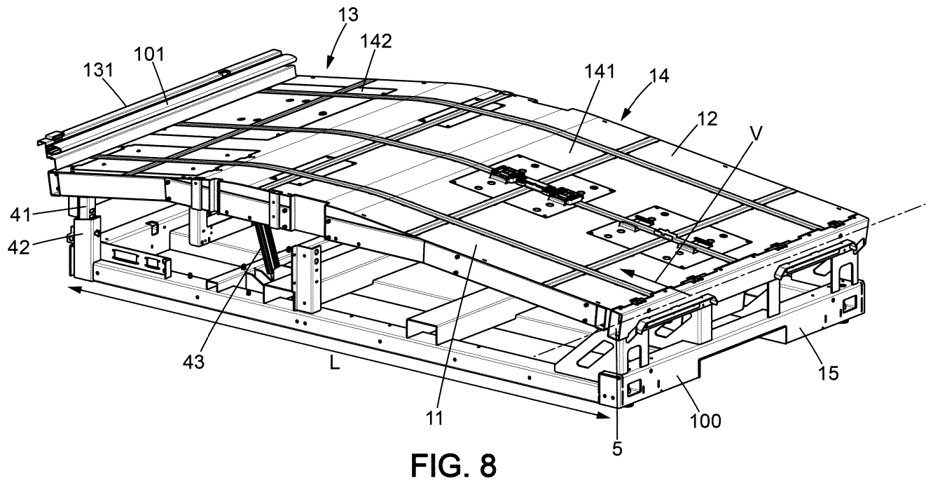

A particular example of a workstation 1, depicted in FIGS. 8 to 10, will now be described.

In these figures, the movable part 14 of the conveyor track 10 is particularly visible, while the fixed part 15 is not depicted. The movable part 14 is movable with respect to the frame 100 on which the fixed part 15 is mounted.

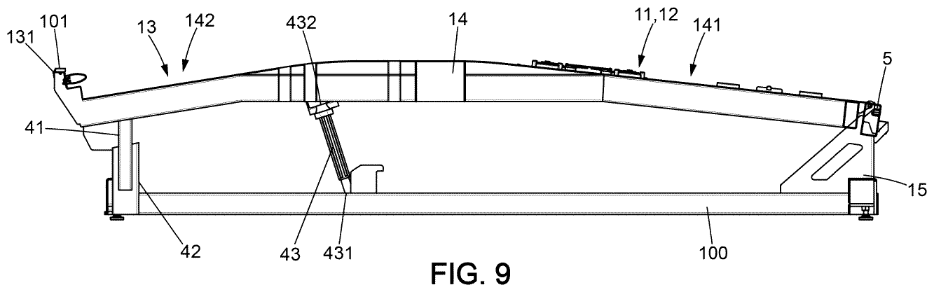

According to this example, and especially with reference to FIG. 9, the movable part 14 comprises a first track portion 141 inclined so that it ascends as the distal end 101 is approached, and the working portion 13 forms a second track portion 142 inclined at an angle opposite to that of the first track portion 141. In fact, the second portion 142 descends toward the distal end 101. In this fashion, the workstation is configured to incline, towards the working area Z, a container 2 routed on the working portion 13.

By “incline towards the working area” it is understood that the working portion 13 comprises a low point located at the working edge 131, in the vicinity of the working area Z of the operator.

In this fashion, if a container 2 is open at the top, a bottom of the container 2 is more easily accessible by virtue of this inclination.

Additionally, according to one example, and in especially as depicted in FIGS. 8 to 10, the adjustment mechanism 4 may comprise means for manually adjusting the height of the working portion 13.

Especially, the workstation 1 can comprise a toothed component 41 mounted at a distance, according to general direction V, from the joint 5 on one of either the fixed part 15 or the movable part 14 of the conveyor track 10, and a complementary component 42 mounted on the other of the fixed part 15 or the movable part 14 of the conveyor track 10, the toothed component 41 comprising a plurality of teeth corresponding to several height values of the working portion 13 of the conveyor track 10, a tooth of the toothed component 41 being configured to cooperate with the complementary component 42 to manually adjust the working portion 13 to a selected height.

In this fashion, it is possible for an operator, using a jack for example, to raise the distal end 101 of the movable part 14 to a desired height, and to engage a tooth of the toothed component 41 with the complementary component 42 to manually adjust the height of the working portion 13 to the desired height.

According to certain examples, the internal adjustment mechanism 4 can further comprise means for automatically adjusting the height of the working portion 13.

In fact, the workstation 1 can comprise an actuator 43, with a first end 431 pivotally mounted on the fixed part 15 of the conveyor track 10, or directly fixed to the frame 100, and with a second end 432 pivotally mounted on the movable part 14, in such a way that an extension or retraction of the actuator allows the height of the working portion 13 to be adjusted.

In fact, the working portion 13 is typically located in the vicinity of the distal end 101 of the movable part 14, so that a rotation at the joint 5 of the movable part 14 with respect to the fixed part 15 generates a variation in height ΔH at the working portion 13.

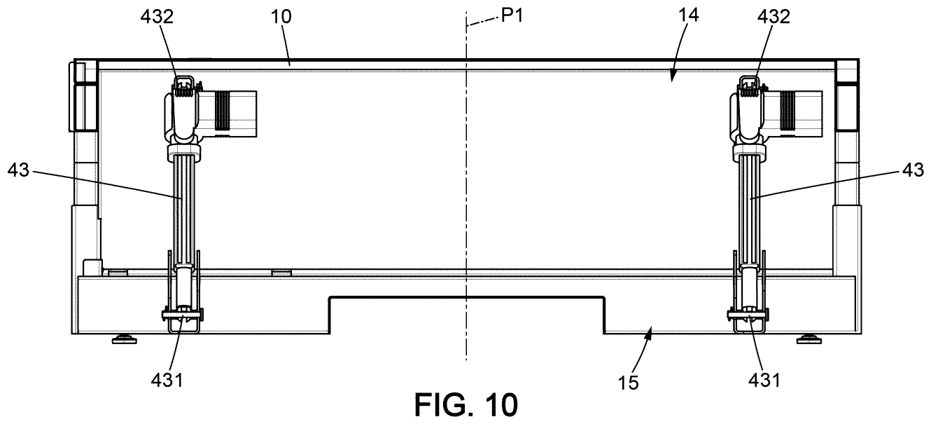

According to a particular example, and especially as depicted in FIG. 10, the internal adjustment mechanism 4 comprises two cylinders, each positioned on both sides of a longitudinal median plane P1 of the conveyor track 10. Preferentially, the two cylinders are positioned at equal distances from said median plane P1, so that the mechanical forces are balanced between the two cylinders.

Additionally, the workstation 1 can comprise a human-machine interface (not shown) typically connected to a processor and to a memory and via which an operator can transmit a command, for either:
adjusting the height of the working portion 13 to a height value available in the memory, or
increasing or decreasing the height of the working portion 13 to a selected height value.

The present disclosure also relates to a method of preparing orders implemented by a set comprising the workstation 1 and an automated vehicle 7.

According to one example, the method comprises a step wherein a container 2 is routed by an automated vehicle 7 up to the working portion 13, and a step of working on the container 2 performed by an operator.

Typically, during the working step, the operator is positioned in the working area Z, on a first side of a working edge 131 of the working portion 13, and works on containers 2 routed on the working portion 13 from another side of the working edge 131 opposite the first side.

According to an example wherein the workstation 1 comprises a human-machine interface connected to a processor and to a memory, and an actuator as previously described, the method comprises a step of adjusting the height H of the working portion 13 wherein the operator sends an instruction via said human-machine interface to the processor, which drives the actuator to respond to the instruction of the operator. Thus, if the command of the operator is to increase a height of the working portion 13, or to adopt a prerecorded height value that involves raising the working portion 13, the processor drives the actuator so that it extends and raises the movable part 14 that carries the working portion 13.

The cylinder may include a servo control means configured so that the processor can stop the actuator when the selected height value is reached.

Once the working portion 13 has been adjusted according to said instruction, the operator works on the container 2 during a working step.

According to a particular example wherein the workstation comprises a first and second conveyor track 10.1, 10.2 adjustable independently of each other, the method comprises a first step of adjusting the height of the first conveyor track 10.1, wherein the processor drives the first actuator, and a second step of adjusting the height of the second conveyor track 10.2, wherein the processor drives the second actuator, the height adjustment of the first step being independent of the height adjustment of the second step.

Such an example may be advantageous when a first container 2 of a first height is routed up to the first working portion 13.1, and a second container 2 of a second height is routed up to the second working portion 13.2. In fact, especially for ergonomic reasons, the operator can choose a first height value adapted to the first container 2 for the first conveyor track 10.1, and a second height value adapted to the second container 2 for the second conveyor track 10.2.

In this fashion, the difference in size between the two containers 2 can be advantageously compensated for by independent adjustment of the heights of the two tracks of the working portions 13.1, 13.2.

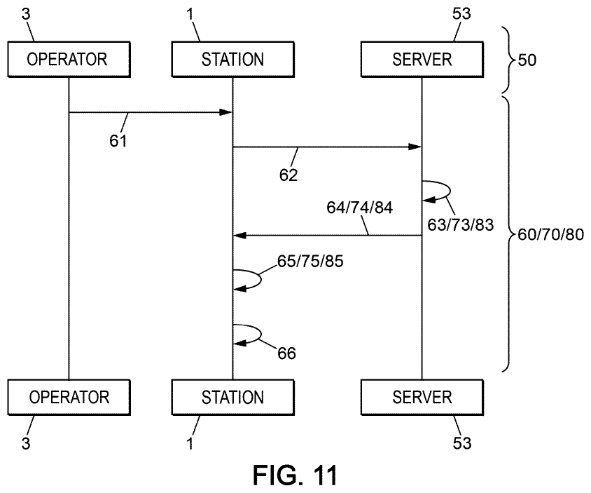

FIG. 11 schematically depicts the sequence of events in an example of a method for managing an order-picking station according to one embodiment of the invention.

The invention relates not only to the method for managing an order-picking station, but also to the associated computer-run program for managing an order-picking station, and to the computer medium that is also associated with same, containing the instructions for implementing the computer-run program for managing an order-picking station. Messages 60 are exchanged between the various entities 50 over a wired or wireless telecommunications or communications network. The entities are the operator 3, the order-picking station 1, also referred to as workstation 1, and the computer server 53. This method for managing an order-picking station 1 is therefore implemented or executed via a wired or wireless telecommunications or communications network.

At the order-picking station 1, also referred to as station 1, a human or robotic operator 3, also referred to as operator 3, places or removes articles in containers carried by automated guided vehicles travelling on a track of the station 1. The automated guided vehicles are automatic transport vehicles.

The server 53 is remote from the station 1, and is also connected to several other order-picking stations. The server 53 therefore manages several order-picking stations, similar or identical to the station 1. The order-picking station 1 therefore belongs to a group of several order-picking stations within the same article storage warehouse. The server 53 can be a dedicated machine, or a software service operating in client-server mode, with the client part located at the order-picking station, and the server part located elsewhere, advantageously outside the order-picking station.

The method for managing an order-picking station 1 can be carried out in different ways, by performing a sequence of steps in one or more cycles. Each cycle corresponds to one sequence of steps. The invention proposes three cycles: a first cycle, a second cycle, and a third cycle. In one embodiment, the first cycle is referred to as operator cycle, the second cycle is referred to as container cycle, and the third cycle is referred to as depth cycle. The cycles can preferentially be run consecutively, which simplifies the management method as a whole. The cycles may optionally be run in an overlapping manner. Some or all of the cycles proposed by the invention can be carried out.

The method for managing an order-picking station 1 can take place as follows, with every change of operator 3 at the station 1, by consecutively carrying out the steps that will be described hereinafter and which form a first operator cycle.

In a first step of this first operator cycle, the operator 3 logs into their station 1, using their identifier. The operator identifies 61 themselves to their station 1, this identification 61 also being their authentication to the station 1. The identifier of the operator 3 can be, for example, either in the form of a barcode to be read by a scanner of the order-picking station 1, or in the form of facial recognition of the operator 3 that is seen by a camera of the order-picking station 1.

In a second step of this first operator cycle, once the operator 3 has logged in and identified themselves to their station 1, the station 1 sends a personalization request 62, including the identifier of the operator 3, to the server 53.

In a third step of this first operator cycle, the server 53, once it has received the identifier of the operator 3, determines 63, from this identifier of the operator 3, information for adjusting the height of the track to the operator 3. In some cases, this determination 63 can be reduced to a simple retrieval of this information for adjusting the height of the track to the operator 3, if this information for adjusting the height of the track to the operator 3 already exists and has already been stored in a memory that is accessible to the server 53. During the determining step 63, the information for adjusting the height of the track is preferably determined in such a way that the cumulative height, from the warehouse floor, of the container carried by the automated guided vehicle travelling on the track, is adapted to the operator 3. During the determining step 63, the information for adjusting the height of the track is preferably even determined in such a way that the cumulative height, from the warehouse floor, of the container carried by the automated guided vehicle travelling on the track, is adapted to the height of the operator 3 standing on the warehouse floor.

In addition to the height of the track, the server 53 can also determine and add to the adjustment information at least one other ergonomic characteristic of the track or of the order-picking station 1. This other ergonomic characteristic is advantageously a function dependent on the height of the track.

In one embodiment, this other ergonomic characteristic or one of the other ergonomic characteristics is an inclination of the track towards the operator 3 at the level of the operator 3.

In further alternative or cumulative embodiments, this other ergonomic characteristic or one of the other ergonomic characteristics may be:
the height of a scanner of the track or of the order-picking station 1,
and/or the height of a screen of the track or of the order-picking station 1,
and/or a parameter of the display on a screen of the track or of the order-picking station 1, especially among the color palette used for the display on a screen of the track or the display language on a screen of the track,
and/or the replacement of one type of alert with another type of alert, at the order-picking station 1, for example the replacement of an audible alert with a visual alert displayed on a screen of the order-picking station 1.

As an alternative to these first three steps of the first operator cycle, the information for adjusting the height of the track is obtained from the human operator's posture within the intervention area Z. In a first step, the operator positions themselves in the intervention area Z of the order-picking station 1. A camera captures images or video streams of the operator performing operations on the containers. In a second step, these images or video streams are transmitted, notably in real time, to server 53 for functional analysis of the operator's posture. In the third step, server 53 analyzes, in real time, the operator's body positions and determines, based on these positions, the information for adjusting the height of the track to the operator.

In a fourth step of this first operator cycle, the server 53 returns 64 a personalization response including the previously determined adjustment information to the station 1. Optionally, the personalization response can also include additional information for adjusting the height of an additional track of the station 1.

In a fifth step of this first operator cycle, an internal mechanism of the station 1 automatically performs a first action 65 to adjust the height of the track with respect to the warehouse floor, on the basis of the adjustment information contained in the personalization response. This internal mechanism also automatically, and where appropriate dynamically, modifies this other ergonomic characteristic to match the adjustment information, when the adjustment information includes such an additional ergonomic characteristic.

At the station 1, in addition to the automatic adjustments previously made during the first operator cycle 60, the operator 3 can fine-tune the height of the track by manual adjustment, by sending, at the station 1, an instruction for the internal mechanism to raise or lower the height of the track. This mechanism then fine-tunes the height of the track to match the instruction.

In other alternative or cumulative embodiments, previously mentioned, the internal mechanism of the station also automatically performs a complementary action 66 to adjust:
the height of a scanner of the track or of the order-picking station 1,
and/or the height of a screen of the track or of the order-picking station 1,
and/or a parameter of the display on a screen of the track or of the order-picking station 1, especially among the color palette used for the display on a screen of the track or the display language on a screen of the track,
and/or replacing one type of alert with another type of alert, at the order-picking station 1, for example replacing an audible alert with a visual alert displayed on a screen of the order-picking station 1.

The computer server 53 preferentially comprises a first sub-server and a second sub-server, which work together. The first sub-server is dedicated to the warehouse staff, and manages the adjustment information. The second sub-server is dedicated to managing container flows within the warehouse, and manages the dynamically adapted adjustment information. The containers can be empty containers, and/or containers filled with identical articles from an article storage area in the warehouse, and/or containers filled with identical or different articles directed towards an order storage area or an order dispatch area.

In a first option, as an alternative to the first operator cycle or in addition to the first operator cycle, the method for managing an order-picking station 1 can take place as follows, each time the type of container 2 or the type of loading of the container 2 at the station 1 changes, by consecutively carrying out the steps which will be described hereunder and which form a second container cycle for dynamically adapting the height of the track of the station 1. Only the differences with the first operator cycle 60 are described hereunder, as the other aspects and options of the first operator cycle 60 can also be used in conjunction with the second container cycle 70.

In a first step of this second container cycle 70, each time a new type of container arrives on the track, or the loading of the container arriving on the track changes, the server 53 dynamically adapts 73 the information for adjusting the height of the track so that the cumulative height, from the warehouse floor, of the new type of container carried by the automated guided vehicle travelling on the track, remains adapted to the operator 3.

In a second step of this second container cycle 70, the server 53 returns 74 dynamically adapted adjustment information to the station 1.

In a third step of this second container cycle 70, the internal mechanism 4 of the station 1 performs a second action 75 of automatically and dynamically adjusting the height of the track with respect to the warehouse floor, on the basis of the dynamically adapted adjustment information, at the moment at which the new type of container carried by the automated guided vehicle travelling on the track reaches the operator 3.

At the station 1, in addition to the one or more automatic adjustments previously made during this second container cycle, the operator 3 can fine-tune the height of the track by manual adjustment, by sending, at the station 1, an instruction for the internal mechanism to raise or lower the height of the track. This mechanism then fine-tunes the height of the track to match the instruction.

In a second option, as an alternative to the first operator cycle or in addition to the first operator cycle, as an alternative to the second container cycle or in addition to the second container cycle, the method for managing an order-picking station 1 can take place as follows, at each change of depth at which the operator places or removes an article, by consecutively carrying out the steps that will be described hereunder and which form a third depth cycle 80 for dynamically adapting the height of the track of the station 1. Only the differences with the first operator cycle 60 are described hereunder, as the other aspects and options of the first operator cycle 60 can also be used in conjunction with the third depth cycle 80.

In a first step of this third depth cycle 80, each time the depth at which the operator places or removes an article changes, the server 53 dynamically adapts 83 the information for adjusting the height of the track so that the cumulative height, from the warehouse floor, of the container carried by the automated guided vehicle travelling on the track, subtracting the depth at which the operator 3 places or removes an article, as they fill or empty the container, remains adapted to the operator 3.

In a second step of this third depth cycle 80, the server 53 returns 84 dynamically adapted adjustment information to the station 1.

In a third step of this third depth cycle 80, an internal mechanism 4 of the station 1 automatically performs a third action 85 of automatically and dynamically adjusting the height of the track with respect to the floor by means of the internal mechanism 4 of the station 1, on the basis of the dynamically adapted adjustment information, as the operator 3 fills or empties the container 2.

At the station 1, in addition to the one or more automatic adjustments previously made during this third depth cycle 80, the operator 3 can fine-tune the height of the track by manual adjustment, by sending, at the station 1, an instruction for the internal mechanism to raise or lower the height of the track. This mechanism then fine-tunes the height of the track to match the instruction.

Naturally, the present invention is not limited to the examples and embodiments disclosed and depicted, but is susceptible to numerous variants that are available to those skilled in the art.

1. A method for managing an order-picking station, at which a human or robotic operator places or removes articles in containers carried by automated guided vehicles travelling on a track of the station, comprising, upon a change of configuration and/or operation at the station, the following cycle:
determining, by a remote server also connected to several other order-picking stations, after the change in configuration and/or operation at the station, information for adjusting the height of the track to the change in configuration and/or operation at the station,
returning the adjustment information from the remote server to the station,
automatically adjusting the height of the track with respect to the floor by an internal mechanism of the station, on the basis of the adjustment information,
the change of configuration and/or operation including a change of operator,
the cycle also comprising, prior to the determining step, sending an identifier of the operator from the station to the remote server,
the determining step being carried out by the remote server, on the basis of the identifier of the operator, and determining information for adjusting the height of the track to the operator.

2. A method for managing an order-picking station, at which a human or robotic operator places or removes articles in containers carried by automated guided vehicles travelling on a track of the station, comprising, with each change of operator at the station, the following cycle:
sending a personalization request including an identifier of the operator from the station to a remote server also connected to several other order-picking stations,
determining, by the remote server, on the basis of the identifier of the operator, information for adjusting the height of the track to the operator,
returning a personalization response including the adjustment information from the remote server to the station,
automatically adjusting the height of the track with respect to the floor by an internal mechanism of the station, on the basis of the adjustment information.

3. The method for managing an order-picking station according to claim 1, wherein the information for adjusting the height of the track is determined in such a way that the cumulative height, from the floor, of the container carried by the automated guided vehicle travelling on the track, is adapted to the operator.

4. The method for managing an order-picking station according to claim 3, wherein the information for adjusting the height of the track is determined in such a way that the cumulative height, from the floor, of the container carried by the automated guided vehicle travelling on the track, is adapted to the height of the operator standing on the floor.

5. The method for managing an order-picking station according to claim 3, wherein, after the adjustment, each time a new type of container arrives on the track, the method comprises the following container cycle:
dynamically adapting, by the remote server, the information for adjusting the height of the track so that the cumulative height, from the floor, of the new type of container carried by the automated guided vehicle travelling on the track, remains adapted to the operator,
returning dynamically adapted adjustment information from the remote server to the station,
automatically and dynamically adjusting the height of the track with respect to the floor by the internal mechanism of the station, on the basis of the dynamically adapted adjustment information, at the moment at which the new type of container carried by the automated guided vehicle travelling on the track reaches the operator (3).

6. The method for managing an order-picking station according to claim 5, wherein after the one or more adjustments, at each change of depth at which the operator places or removes an article, the method comprises the following depth cycle:
dynamically adapting, by the remote server, the information for adjusting the height of the track so that the cumulative height, from the floor, of the container carried by the automated guided vehicle travelling on the track, subtracting the depth at which the operator places or removes an article, as they fill or empty the container, remains adapted to the operator,
returning dynamically adapted adjustment information from the remote server to the station,
automatically and dynamically adjusting the height of the track with respect to the floor by the internal mechanism of the station, on the basis of the dynamically adapted adjustment information, as the operator fills or empties the container.

7. The method for managing an order-picking station according to claim 1, wherein, in addition to the one or more automatic adjustments, the operator can fine-tune the height of the track by manual adjustment, by sending, at the station, an instruction to raise or lower the height of the track to the internal mechanism, which then fine-tunes the height of the track to match the instruction.

8. The method for managing an order-picking station according to claim 1, wherein the total vertical travel for adjusting the height of the track is between 100 mm and 300 mm, or between 150 mm and 250 mm.

9. The method for managing an order-picking station according to claim 3, wherein the cumulative height is between 800 mm and 1600 mm, or between 1000 mm and 1400 mm.

10. The method for managing an order-picking station according to claim 1, wherein:
in addition to the height of the track, the adjustment information also includes at least one other ergonomic characteristic of the track or of the order-picking station, this other ergonomic characteristic being a function dependent on the height of the track.
the internal mechanism also automatically, and where appropriate dynamically, modifies this other ergonomic characteristic to match the adjustment information.

11. The method for managing an order-picking station according to claim 10, wherein:
the other ergonomic characteristic or one of the other ergonomic characteristics belongs to the following list of ergonomic characteristics:
an inclination of the track towards the operator at the level of the operator,
the height of a scanner of the track or of the order-picking station,
the height of a screen of the track or of the order-picking station,
a display parameter on a screen of the track or of the order-picking station (1), especially one of the following:
the color palette used for the display on a screen of the track,
the display language on a screen of the track,
the replacement of one type of alert with another type of alert, at the order-picking station (1):
for example, the replacement of an audible alert with a visual alert displayed on a screen of the order-picking station.

12. The method for managing an order-picking station according to claim 1, wherein:
the circulation track of the station comprises, consecutively from the floor:
a first stationary portion in the form of a first ascent ramp with a fixed slope,
a second movable portion comprising:
a second ascent ramp with a variable slope, connected by a pivot to the first ramp,
a third descent ramp towards the operator, with a fixed or variable slope,
the height of the track is changed by moving the second movable portion.

13. The method for managing an order-picking station according to claim 1, wherein:
the personalization response comprises additional information for adjusting the height of an additional track of the station,
the internal mechanism of the station also automatically adjusts the height of the additional track with respect to the floor, based on the additional adjustment information.

14. The method for managing an order-picking station according to claim 13, wherein:
either the height of the track contained in the adjustment information is identical to the height of the additional track contained in the additional adjustment information,
or the height of the track contained in the adjustment information is different from the height of the additional track contained in the additional adjustment information.

15. The method for managing an order-picking station according to claim 13, wherein:
the track of the station is a track for the circulation of containers carried by automated guided vehicles, the containers reaching the operator empty, the operator then filling them with articles,
and leaving the operator filled,
the additional track of the station is a track for the circulation of containers carried by automated guided vehicles, the containers:
reaching the operator full, the operator then emptying them of their articles,
and leaving the operator empty.

16. The method for managing an order-picking station according to claim 1, wherein the internal mechanism of the station comprises one or more cylinders, preferably two cylinders, located under the track or under the tracks, so as to be able to raise or lower the track or the tracks.

17. The method for managing an order-picking station according to claim 1, wherein the cycle comprises, before sending the personalization request, the operator logging into their station using their identifier.

18. The method for managing an order-picking station according to claim 17, wherein:
the identifier of the operator is:
either in the form of a barcode that is to be read by a scanner of the order-picking station,
or in the form of facial recognition of the operator that is to be seen by a camera of the order-picking station.

19. The method for managing an order-picking station, belonging to a group of order-picking stations in a warehouse, according to claim 1, wherein:
the remote server comprises:
a first sub-server,
dedicated to the warehouse staff,
managing the adjustment information,
a second sub-server,
dedicated to managing the flow of containers within the warehouse,
of empty containers,
and/or of containers filled with identical articles coming from an article storage area in the warehouse,
and/or of containers filled with identical or different articles directed towards
an order storage area or an order dispatch area,
managing the dynamically adapted adjustment information.
